(19) United States
(12) Patent Application Publication
(10) Pub. No.: US 2023/0153634 A1
(43) Pub. Date: May 18, 2023

(54) COMPOSITE FEATURE ENGINEERING

(71) Applicants: International Business Machines Corporation, Armonk, NY (US); Massachusetts Institute of Technology, Cambridge, MA (US)

(72) Inventors: Dakuo Wang, Cambridge, MA (US); Udayan Khurana, White Plains, NY (US); Chuang Gan, Cambridge, MA (US); Gregory Bramble, Larchmont, NY (US); Abel Valente, Buenos Aires (AR); Arunima Chaudhary, Dehradun (IN); Carolina Maria Spina, Olavarria (AR); Micah Smith, Boston, MA (US)

(21) Appl. No.: 17/525,932

(22) Filed: Nov. 14, 2021

(51) Int. Cl. G06N 5/02; G06F 9/451

(52) U.S. Cl. CPC G06N 5/02; G06F 9/451

(57) ABSTRACT

A domain of an input dataset is identified and one or more archived domain knowledge features corresponding to the identified domain are identified. One or more user feature definitions for one or more user features defined by a user are inputted. The identified archived domain knowledge features and the user features are processed to generate a set of candidate features for presentation to the user. A selection of a subset of the candidate features is obtained from the user and one or more predictive models are generated based on the selected features.

### BACKGROUND

The present invention relates to the electrical, electronic and computer arts, and more specifically, to feature engineering systems.

Feature engineering uses domain knowledge in the extraction of features from data which may then be used, for example, to generate predictive models. The feature may specify a characteristic, property, or attribute of the data under consideration. Parameter optimization selects the best features for use in generating the model. Conventionally, the domain knowledge is provided by a human expert who crafts new features or specifies existing features that may prove of value to the predictive model. While Automatic Artificial Intelligence/Automatic Machine Learning (AutoAI/AutoML) encompasses the use of programs and algorithms to automate the whole end-to-end AI workflow, the current state of automation of feature engineering is primitive, often using brute-force to apply candidate transformation methods to existing features in the dataset.

### SUMMARY

Principles of the invention provide techniques for feature engineering. In one aspect, an exemplary method includes the operations of identifying, using at least one processor, a domain of an input dataset; identifying, using the at least one processor, one or more archived domain knowledge features corresponding to the identified domain; inputting, using the at least one processor, one or more user feature definitions for one or more user features defined by a user; processing, using the at least one processor, the identified archived domain knowledge features and the user features to generate a set of candidate features for presentation to the user; obtaining, using the at least one processor, a selection of a subset of the candidate features from the user; and generating, using the at least one processor, one or more predictive models based on the selected features.

In one aspect, an apparatus comprises a memory and at least one processor, coupled to the memory, and operative to perform operations comprising identifying a domain of an input dataset; identifying one or more archived domain knowledge features corresponding to the identified domain; inputting one or more user feature definitions for one or more user features defined by a user; processing the identified archived domain knowledge features and the user features to generate a set of candidate features for presentation to the user; obtaining a selection of a subset of the candidate features from the user; and generating one or more predictive models based on the selected features.

In one aspect, a computer program product for federated learning comprises a computer readable storage medium having program instructions embodied therewith, the program instructions executable by a computer to cause the computer to perform operations comprising identifying a domain of an input dataset; identifying one or more archived domain knowledge features corresponding to the identified domain; inputting one or more user feature definitions for one or more user features defined by a user; processing the identified archived domain knowledge features and the user features to generate a set of candidate features for presentation to the user; obtaining a selection of a subset of the candidate features from the user; and generating one or more predictive models based on the selected features.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments provide one or more of:

integration of human feature engineering and artificial intelligence (AI) feature engineering;

enabling of multiple data scientists (users) to collaboratively create new features; and

improved predictive models based on improved feature crafting and selection.

Some embodiments may not have these potential advantages and these potential advantages are not necessarily required of all embodiments. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1A illustrates a user interface (UI) for feature engineering, in accordance with an example embodiment;

FIG. 1B illustrates the user interface (UI) for feature engineering with a new feature window, in accordance with an example embodiment;

FIG. 1C illustrates the user interface (UI) for feature engineering overlaid with a feature definition window, in accordance with an example embodiment;

FIG. 1D illustrates the user interface (UI) for feature engineering with the addition of a new feature, in accordance with an example embodiment;

FIG. 2 illustrates a programmatic interface (PI) for feature engineering, in accordance with an example embodiment;

FIG. 3 illustrates the results of performing automatic feature engineering based on the input illustrated in FIG. 2, in accordance with an example embodiment;

FIG. 4 illustrates a set of instructions for using the programmatic interface (PI) of FIG. 2 to import a new feature, in accordance with an example embodiment;

FIG. 5 is a block diagram for a composite feature engineering system, in accordance with an example embodiment;

FIG. 6 is a flowchart of an example method for controlling the composite feature engineering system, in accordance with an example embodiment;

FIG. 7 depicts a cloud computing environment according to an embodiment of the present invention;

FIG. 8 depicts abstraction model layers according to an embodiment of the present invention; and

FIG. 9 depicts a computer system that may be useful in implementing one or more aspects and/or elements of the invention, also representative of a cloud computing node according to an embodiment of the present invention.

### DETAILED DESCRIPTION

Generally, systems and methods for feature engineering are disclosed. In one example embodiment, an exemplary feature engineering system enables the integration of feature engineering provided by a human with feature engineering generated using artificial intelligence. The exemplary system also enables multiple data scientists (users) to collaboratively create new features. Conventional AutoML automatically generates generally primitive features, often applying a set of rules to existing features to create the new features, such as Sqrt(X₁) (taking the square root of a feature, such as body weight) and PCA(X₁ . . . Xₙ) (principle component analysis of a feature), and typically does not work collaboratively with human users. While a more complex feature, such as body mass index (BMI), may be valuable for model generation, AutoML is generally incapable of identifying a feature containing a formula, such as the formula for BMI (weight/height), as a new feature. In one example embodiment, an interactive automated feature generation system and user interface enables multiple users and an AutoML system to work together in the feature engineering task, including the crafting of complex features. The improved predictive models generated based on the derived feature sets enhance the performance of machine learning systems in performing inferencing in a variety of applications, including natural language processing, self-driving vehicles, and the like.

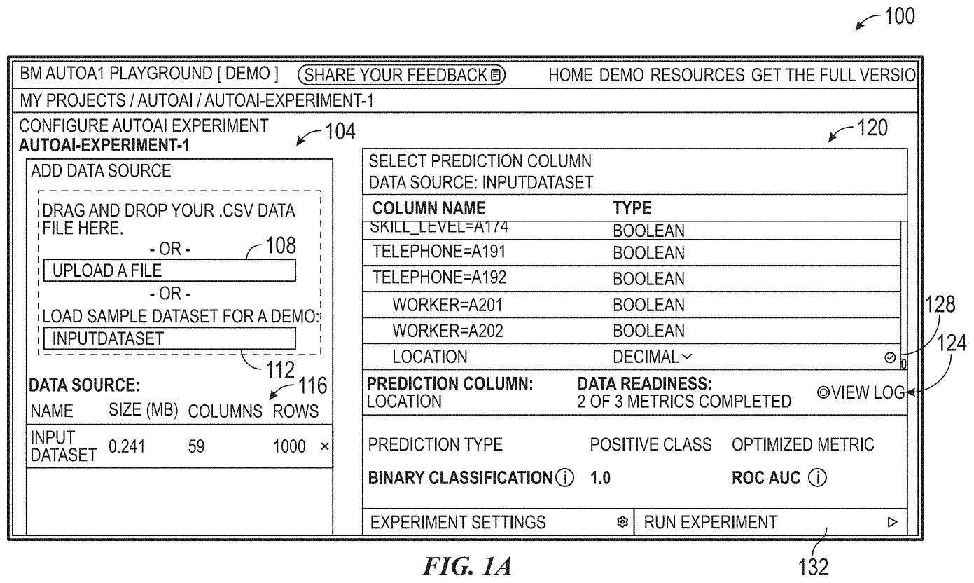

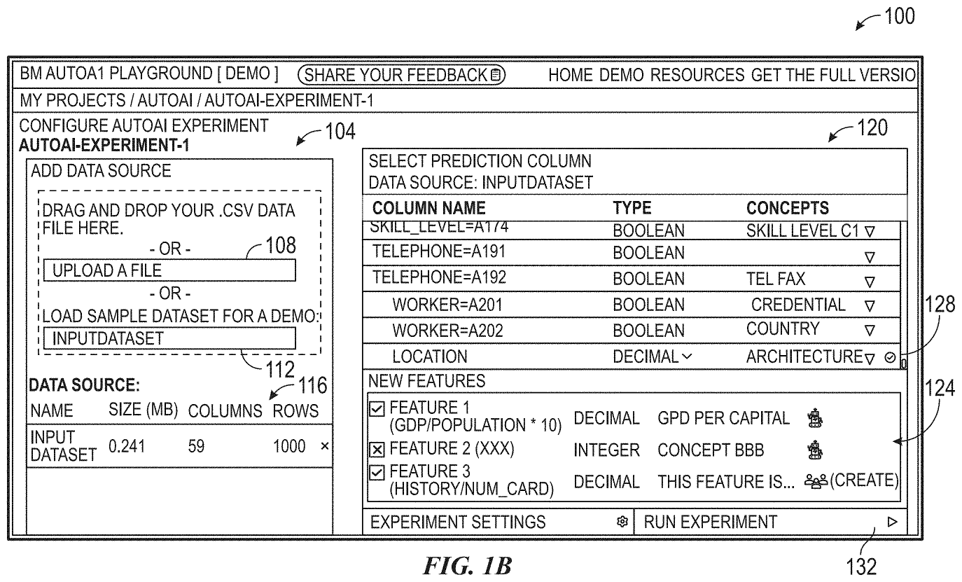

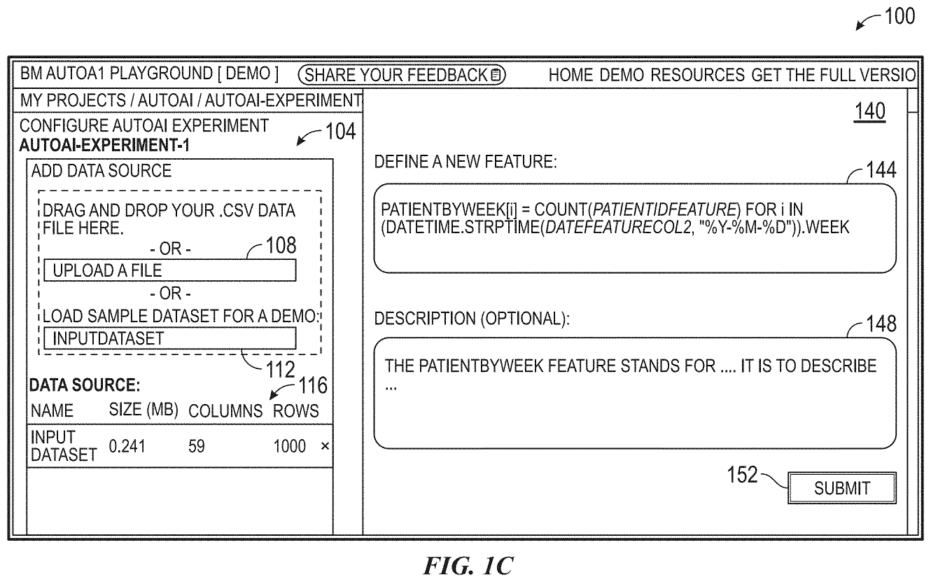

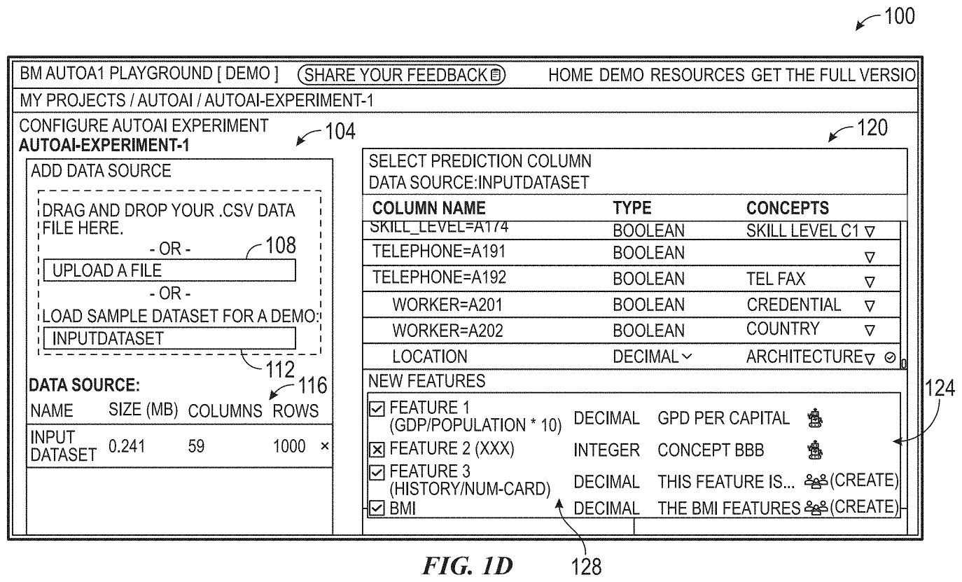

FIG. 1A illustrates a user interface (UI) 100 for feature engineering, in accordance with an example embodiment. A dataset, such as a tabular dataset, may be specified for importation via window 104. For example, the name of a dataset may be entered via input field 108 or a name of a sample dataset for a demonstration may be entered via input field 112. In the illustration of FIG. 1A, a dataset named “InputDataset” that includes 1000 rows of data, each row having 59 columns, is identified in dataset field 116 as being currently loaded.

In one example embodiment, a prediction column selection window 120 shows the columns available for generating the prediction model. A user may deselect one or more of the columns to exclude the deselected features from the generation of the prediction model. As illustrated in FIG. 1A, the data to be predicted, as indicated by checkmark 128, is the “location” column (which represents the location of a corresponding computer in binary form: “local” or “remote”). A binary classification, as indicated in classification window 124, is therefore to be generated for each row of an input dataset where the location of the computer will be identified as either “local” or “remote.” As such, the “location” column is used to train the predictive model, but would not be one of the input features for the generated predictive model; rather, the “location” column will be an output of the predictive model.

FIG. 1B illustrates the user interface (UI) 100 for feature engineering with a new feature window 124, in accordance with an example embodiment. New features to be utilized in generating the model are identified in the new feature window 124. A checkmark indicates a feature that has been manually selected for utilization in generating the model and an “x” indicates a feature that has been manually selected to be excluded from utilization in generating the model. The features identified in new feature window 124 may be provided by a human or provided by an AI system, as identified by the right-most icon in the new feature window 124. For example, feature 1, “GDP/population*10”, has been generated using AI and has been selected by the user for use in model generation. Feature 2 has been generated using AI and has been excluded from the model generation by the user. Feature 3, “history/number_cards,” has been provided by a user (either the user of the user interface 100 or another user) and has been selected by the user for use in model generation. The formulas of the new features are each used to transform the existing data of the dataset to generate a new column representing the new feature. Once the full set of features has been selected, the user may select the “run experiment” icon 132 to generate and evaluate the model, such as a deep learning model, a simple regression model, and the like, based on the selected features.

FIG. 1C illustrates the user interface (UI) 100 for feature engineering overlaid with a feature definition window 140, in accordance with an example embodiment. A new feature may be defined in feature input field 144 and the corresponding textual description may be entered in feature description input field 148, where the italicized text is the name of a column of the dataset. Once entered, the feature definition information is submitted for processing by selecting the submit icon 152. The new feature will be added to the set of features displayed in the user interface 100 and will be archived for use in the future.

FIG. 1D illustrates the user interface (UI) 100 for feature engineering with the addition of a new feature, in accordance with an example embodiment. New features to be utilized in generating the model are identified in new feature window 124. As illustrated in FIG. 1D, a new feature 128, body mass index (BMI), has been added to the feature set by a user and has been selected for use in generating the model.

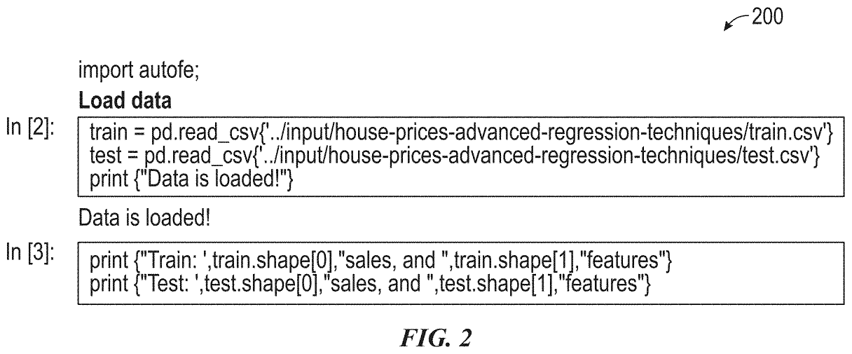

FIG. 2 illustrates a programmatic interface (PI) 200 for feature engineering, in accordance with an example embodiment. The user can use a programming user interface to write one or more code sequences to perform a data loading function, then for the user specified dataset, further functions can be performed. In the example of FIG. 2, training and test datasets for house process are specified as .csv filed with the indicated names, a message “Data is loaded!” is printed out once the training and test data is loaded, and then the sales and features are printed out for the training and test datasets.

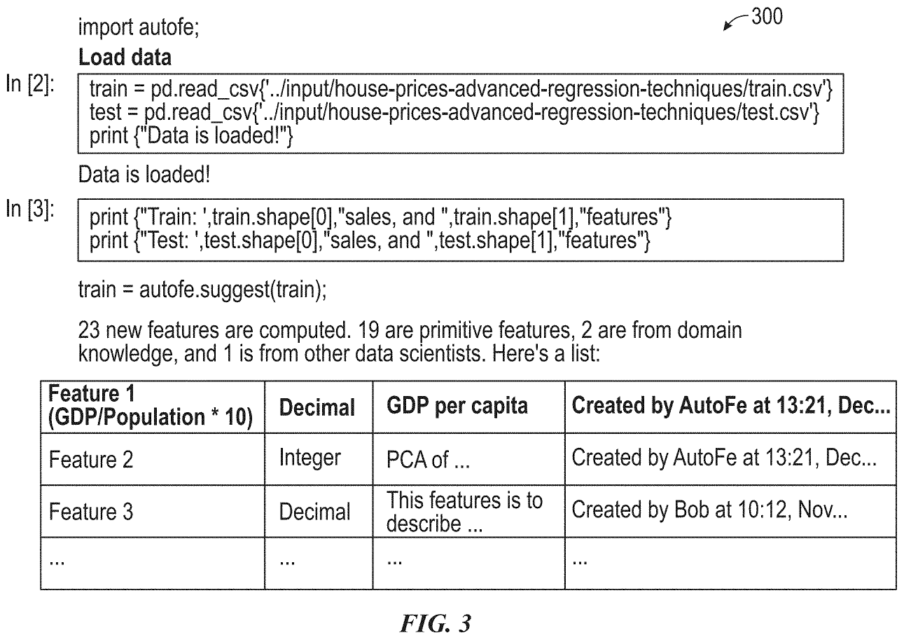

FIG. 3 illustrates the results of performing automatic feature engineering based on the input illustrated in FIG. 2, in accordance with an example embodiment. The algorithm autofe.suggest suggests features for the dataset “train.” In the example of FIG. 3, 23 new features have been computed (based on instructions 300) of which 19 are primitive features, two are the result of domain knowledge (generated using AI or provided by a user), and one was provided by other users.

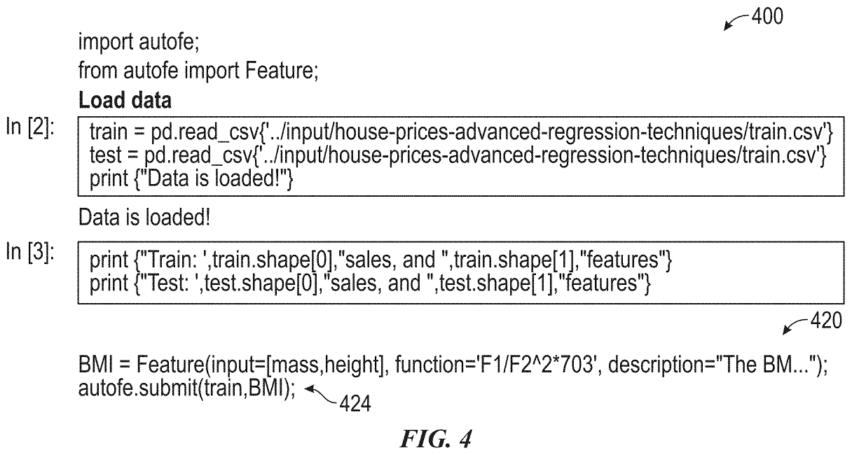

FIG. 4 illustrates a set of instructions 400 for using the programmatic interface (PI) 200 of FIG. 2 to import a new feature 420, in accordance with an example embodiment. A new class named “feature” is utilized to enter the new feature 420. As illustrated in FIG. 4, the new feature 420 is a body mass index (BMI) feature based on the following formula: weight(kg)/height(cm)²*10,000. Instruction 424 generates the new feature 420, where “train” is the dataset name and BMI is the feature. Note that the BMI feature is chosen simply for illustrative purposes and is not necessarily relevant to house prices.

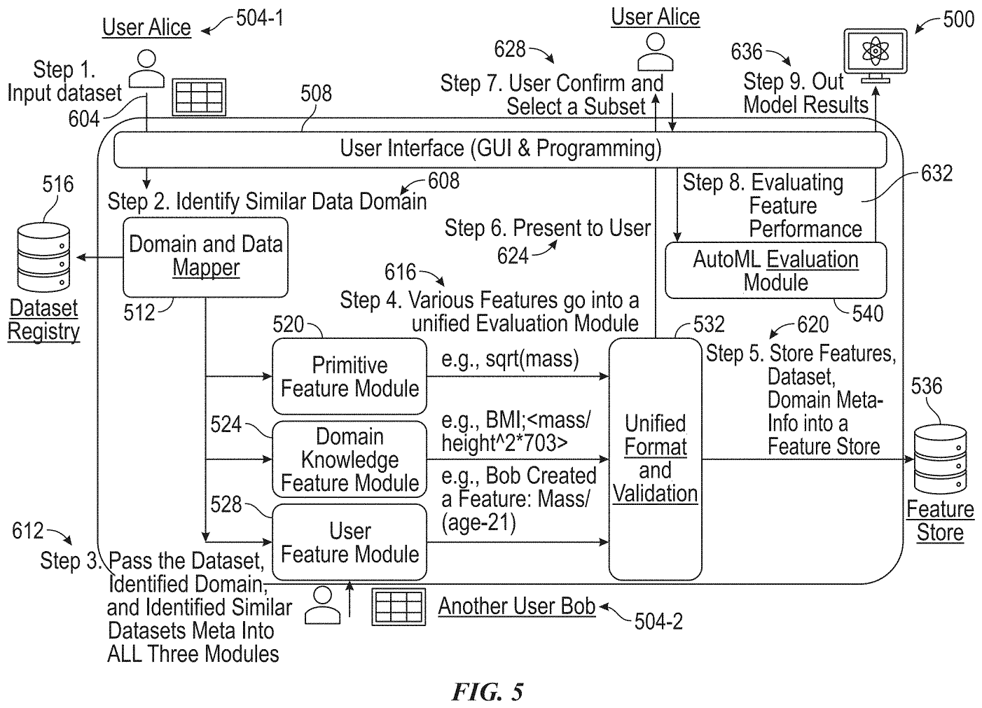

FIG. 5 is a block diagram for a composite feature engineering system 500, in accordance with an example embodiment. A user 504-1 is able to specify datasets for processing, define and/or select model generation algorithms, and define and/or select features for use in the generation of the model, including features that are manually entered via a user interface unit 508, features that are generated using AI, and the like. In one example embodiment, the user interface unit 508 provides the user interface (UI) 100 and/or the programmatic interface (PI) 200. Suitable GUI techniques are discussed below.

The dataset registry 516 maintains archived datasets, feature sets that have been defined in the past for one or more of the archived datasets, datasets associated with other users, and domain identifiers for at least a subset of the archived datasets. For example, dataset registry 516 includes a particular dataset that the current user uploaded and used, but since there are typically many other users of the system, who also upload their own datasets. These datasets uploaded by different users (or the same user, but in the past) are also included in dataset registry 516 in one or more embodiments. A similarity match can be sued to decide which historical dataset(s) is/are more similar to the current one

The domain and data mapper 512 performs a number of tasks related to exploiting domain knowledge for feature engineering. In one example embodiment, the domain and data mapper 512 checks if the input dataset is the same as an existing dataset in the dataset registry 516. For example, the input dataset may be compared to other datasets archived in the dataset registry 516. If the dataset, or a similar dataset, already exists, the identity of the domain for the existing dataset is accessed in the dataset registry 516. Where one or more similar datasets are available, the search can leverage existing dataset similarity comparison methods. The domain may also be identified by analyzing the data within the dataset or may be entered by a user via the user interface unit 508. The output of the domain and data mapper 512 includes the dataset to be processed, the identity of the corresponding domain, and metadata for the datasets in the dataset registry 516 that have been identified as being similar to the input dataset, if any. The metadata includes, for example, sets of features previously identified for use in model generation for the corresponding similar dataset(s). The output of the domain and data mapper 512 is provided to a primitive feature module 520, a domain knowledge feature module 524, and a user feature module 528, as described more fully below. The domain and data mapper 512 can be implemented, for example, using neural network-based learning by having a human expert prepare training data hand-mapping input datasets to the outputs of dataset to be processed, the identity of the corresponding domain, and metadata for the datasets in the dataset registry 516 that have been identified as being similar to the input dataset, if any. The trained neural network then automates these functions in the domain and data mapper 512.

The primitive feature module 520 provides basic features for the generation of the model. Such primitive features include the data attributes for each column of the dataset, and features based on known formulas and rules, such as Sqrt(X₁) and PCA(X₁ . . . Xₙ), that utilize one or more of the data attributes (corresponding to a column) of the dataset as parameters for the formula or rule. In one example embodiment, the primitive feature module 520 is implemented based on techniques disclosed in co-assigned U.S. Pat. No. 11,048,718 B2, which teaches applying a plurality of transformations to a set of features in each of a plurality of datasets, with an output of each of the plurality of transformations being a score. Refer also to Udayan Khurana, Deepak Turaga, Horst Samulowitz, and Srinivasan Parthasrathy, Cognito: Automated feature engineering for supervised learning, In 2016 IEEE 16th International Conference on Data Mining Workshops (ICDMW) 2016 Dec. 12 (pp. 1304-1307). For each of the sets of features, those of the plurality of transformations for which said score is above a predetermined threshold are selected. A signal representative of the selection is generated. Herein, the selected features can be employed. Generally, module 520 can be rule-based, applying known feature transformation methods. The skilled artisan will be familiar with implementation of rule-based techniques; for example, coding the rules into a series of conditional statements in a high-level computer programming language and then compiling or interpreting them into machine-executable code.

The domain knowledge feature module 524 identifies features generated using domain knowledge that are to be included in generating the model. The domain knowledge features may be identified by the metadata for the identified similar datasets obtained from the dataset registry 516. In one example embodiment, a knowledge graph relates columns of a dataset to tags that, for example, represent an online encyclopedia page, an online encyclopedia concept, and the like. The tags can be utilized to access the pages, concepts, and the like and to craft new derivative features. The domain knowledge feature module 524 can be implemented, for example, using neural network-based learning by having a human expert prepare training data hand-mapping input (i.e., above-discussed output of the domain and data mapper 512) to the output of features that are to be included. The trained neural network then automates these functions in the domain knowledge feature module 524.

The user feature module 528 enables various users, such as user 504-1, and additional users, such as user 504-2, to define and incorporate features. The user features may be based on domain knowledge of the user 504-1, 504-2. In one example embodiment, the user features are entered via user interface 100 and/or the programmatic interface (PI) 200. The user feature module 528 can be implemented using well-known user interface techniques, such as a graphical user interface (GUI) as discussed below, to obtain a user selection of features.

The outputs of the primitive feature module 520, the domain knowledge feature module 524, and the user feature module 528 are provided to a unified format and validation (UFV) module 532. The information provided to the UFV module 532 may exist in different formats. For example, some features may be formatted in regular expression(s) with limited details, while others may have a large amount of descriptive text and details, and a full function definition block. These features will typically need to be aligned into, for example, the same JavaScript Object Notation (JSON) definition with the same fields of the JSON structure (e.g., feature name, feature function, feature raw inputs, feature description, feature creator, feature time, and the like). The UFV module 532 reformats the received information, where necessary, to a format supported, for example, by an evaluation module 540. In addition, the UFV module 532 checks the validity of features provided by the primitive feature module 520, the domain knowledge feature module 524, the user feature module 528, or any combination thereof. For example, one version of a feature that appears as a duplicate, such as a feature provided by both a user 504-1, 504-2 and the domain knowledge feature module 524, may be invalidated and deleted. The output of the UFV module 532 includes the features to be used for model generation after reformatting and/or validating, as necessary. The unified format and validation (UFV) module 532 can be implemented using rule-based techniques; as noted above, the skilled artisan will be familiar with implementation of rule-based techniques; for example, coding the rules into a series of conditional statements in a high-level computer programming language and then compiling or interpreting them into machine-executable code. Furthermore, the skilled artisan will be familiar with various languages suitable for parsing/text processing, such as Python, Perl, Java, and the like. The evaluation module 540 can, for example, employ cross-validation, a well-known statistical method used to estimate the skill of machine learning models. Cross-validation is a resampling procedure used to evaluate machine learning models on a limited data sample. For example, k-fold cross-validation has a single parameter called k that refers to the number of groups that a given data sample is to be split into. When a specific value fork is chosen, it may be used in place of k in the reference to the model, such as k=10 becoming 10-fold cross-validation. Typically, shuffle the dataset randomly, split the dataset into k groups, and, for each unique group: take the group as a hold out or test data set, take the remaining groups as a training data set, fit a model on the training set and evaluate it on the test set, retain the evaluation score and discard the model, and summarize the skill of the model using the sample of model evaluation scores.

The features, dataset, domain metadata, and the like are stored in a feature store 536 and/or the dataset registry 516, which, given the teachings herein, can be implemented, for example, using known database techniques or the like. In one example embodiment, the output of the UFV module 532 is also provided to a user, such as user 504-1, for review and, at the discretion of the user, modification. For example, the user 504-1 may exclude certain features from the set(s) of features provided for model generation, may define new sets of features based on the features provided by the UFV module 532, and the like.

The set(s) of features selected by the user are provided to an evaluation module 540. When the “run experiment” icon 132 is selected, a number of different models are generated for the inputted dataset and feature set. In one example embodiment, four models are generated for each of two different algorithms: a gradient boosted decision tree classifier and a gradient boosting classifier. One of the four models has, for example, hyperparameter optimization; one of the four strictly uses primitive features; and so on.

In one example embodiment, a performance score is generated for each model based on one or more benchmark datasets. Cross-validation may be used to split a subset of data that does not participate in training, where the reserved data is used to calculate performance scores (such as accuracy, an F1 score (weighted average of Precision and Recall), mean squared error (MSE), and the like) for all the models, and that score is used to evaluate the models.

One or more embodiments include generating one or more predictive models based on the features selected using techniques disclosed herein, and then carrying out inferencing using one or more of the selected predictive models. As noted above, the improved predictive models generated based on the derived feature sets enhance the performance of machine learning systems in performing inferencing in a variety of applications, including natural language processing, controlling physical systems such as self-driving vehicles, utility (e.g., water, gas, electric) systems, and the like. For example, send signals to the physical system using I/O interfaces 22 and/or network adapter 20, discussed below.

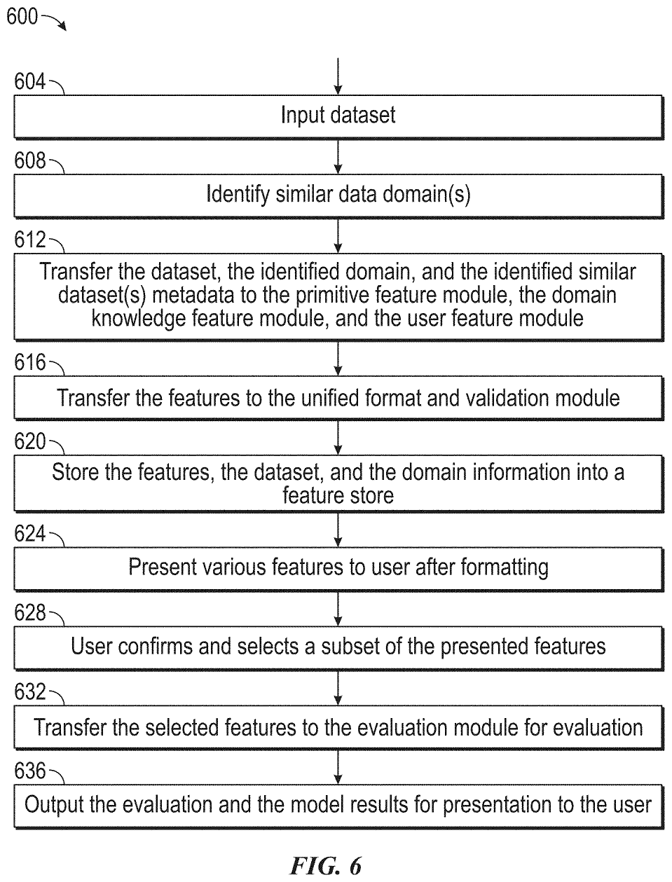

FIG. 6 is a flowchart of an example method for controlling the composite feature engineering system, in accordance with an example embodiment. In one example embodiment, a dataset is input (operation 604) and a similar data domain(s) is identified (operation 608). The dataset, the identified domain, and the identified similar dataset(s) metadata are transferred to the primitive feature module 520, the domain knowledge feature module 524, and the user feature module 528 (operation 612). The features are transferred to the unified format and validation module 532 (operation 616) and are stored with the dataset and the domain information into a feature store (operation 620). The various features are also presented to a user after formatting (operation 624), and the user confirms and selects a subset of the presented features (operation 628). The selected features are transferred to the evaluation module 540 for evaluation (operation 632) and the evaluation and model results are outputted for presentation to the user (operation 636).

Given the discussion thus far, it will be appreciated that, in general terms, an exemplary method, according to an aspect of the invention, includes the operations of identifying, using at least one processor, a domain of an input dataset (e.g. with mapper 512; operation 608); identifying, using the at least one processor, one or more archived domain knowledge features corresponding to the identified domain (e.g. with mapper 512; operation 608); inputting, using the at least one processor, one or more user feature definitions for one or more user features defined by a user (e.g. with interfaces 100, 200, 508); processing, using the at least one processor, the identified archived domain knowledge features and the user features to generate a set of candidate features for presentation to the user (e.g. with modules 520, 524, 528); obtaining, using the at least one processor, a selection of a subset of the candidate features from the user (e.g. with interface 508; operation 628); and generating, using the at least one processor, one or more predictive models based on the selected features (e.g. with module 540; operations 632 and 636).

In one example embodiment, inferencing using one or more of the one or more predictive models is carried out using the at least one processor (e.g. evaluate with module 540 and execute trained models in a known manner; operation 636). In one example embodiment, the processing further comprises providing the candidate features to the user for review and the selection of the subset of the candidate features further comprises one or more modified features generated by the user (e.g. with interface 508, module 528). In one example embodiment, the user feature definitions are inputted via a user interface (UI) 100. In one example embodiment, the user feature definitions are inputted via a programmatic interface (PI) 200.

In one example embodiment, one or more primitive features are generated based on archived formulas, wherein the set of candidate features further comprises the primitive features (e.g. using module 520). In one example embodiment, the processing further comprises checking a validity of one or more of the primitive features, the domain knowledge features, and the user features (e.g. with validation module 532). In one example embodiment, the processing further comprises providing the primitive features, the archived domain knowledge features, and the user features to a user for review and obtaining a modified set of features from the user (e.g. with interface 508; operation 628). In one example embodiment, the identifying the one or more archived domain knowledge features further comprises generating one or more new domain knowledge features by analyzing metadata for one or more archived datasets obtained from a dataset registry 516 that are similar to the input dataset 524.

In one example embodiment, the processing further comprises reformatting (e.g. with module 532) the identified archived domain knowledge features and the user features to comply with a unified format supported by an evaluation module 540. In one example embodiment, the features, the input dataset, and the identified domain are stored in a feature store 536 and/or a dataset registry 516. In one example embodiment, the inferencing is carried out using one or more of the one or more predictive models comprises performing natural language processing using one or more of the one or more predictive models. In one example embodiment, one or more model generation algorithms for the generation of the predictive models are defined by the user using interface 508.

In one example embodiment, one or more model generation algorithms for the generation of the predictive models are selected using interface 508. In one example embodiment, a performance score is generated for each generated predictive model based on one or more benchmark datasets using module 540. In one example embodiment, a knowledge graph that relates columns of the input dataset to tags that represent a concept are generated and a derivative feature is crafted based on the concept, wherein the set of candidate features further comprises the derivative feature (using, e.g., module 524). In one example embodiment, the identifying the domain of the input dataset with mapper 512 further comprises comparing the input dataset to datasets in a dataset registry 516 and accessing an identity of a domain corresponding to a similar existing dataset in the dataset registry 516.

In one example embodiment, the inputting of the one or more feature definitions via the user interface (UI) 100A further comprises defining the corresponding user feature in a feature input field 144 and a corresponding textual description in a feature description input field 148.

In one aspect, an apparatus comprises a memory; and at least one processor, coupled to the memory, and operative to perform operations comprising identifying, using at least one processor, a domain of an input dataset (using, e.g., mapper 512; operation 608); identifying, using the at least one processor, one or more archived domain knowledge features corresponding to the identified domain (using, e.g., mapper 512; operation 608); inputting, using the at least one processor, one or more user feature definitions for one or more user features defined by a user (using, e.g., interfaces 100, 200, 508); processing, using the at least one processor, the identified archived domain knowledge features and the user features to generate a set of candidate features for presentation to the user (using, e.g., modules 520, 524, 528); obtaining, using the at least one processor, a selection of a subset of the candidate features from the user (using, e.g., interface 508; operation 628); and generating, using the at least one processor, one or more predictive models based on the selected features (using, e.g., module 540; operations 632 and 636).

In one aspect, a computer program product for federated learning, the computer program product comprising a computer readable storage medium having program instructions embodied therewith, the program instructions executable by a computer to cause the computer to perform operations comprising identifying, using at least one processor, a domain of an input dataset (using, e.g., mapper 512; operation 608); identifying, using the at least one processor, one or more archived domain knowledge features corresponding to the identified domain (using, e.g., mapper 512; operation 608); inputting, using the at least one processor, one or more user feature definitions for one or more user features defined by a user (using, e.g., interfaces 100, 200, 508); processing, using the at least one processor, the identified archived domain knowledge features and the user features to generate a set of candidate features for presentation to the user (using, e.g., modules 520, 524, 528); obtaining, using the at least one processor, a selection of a subset of the candidate features from the user (using, e.g., interface 508; operation 628); and generating, using the at least one processor, one or more predictive models based on the selected features (using, e.g., module 540; operations 632 and 636).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

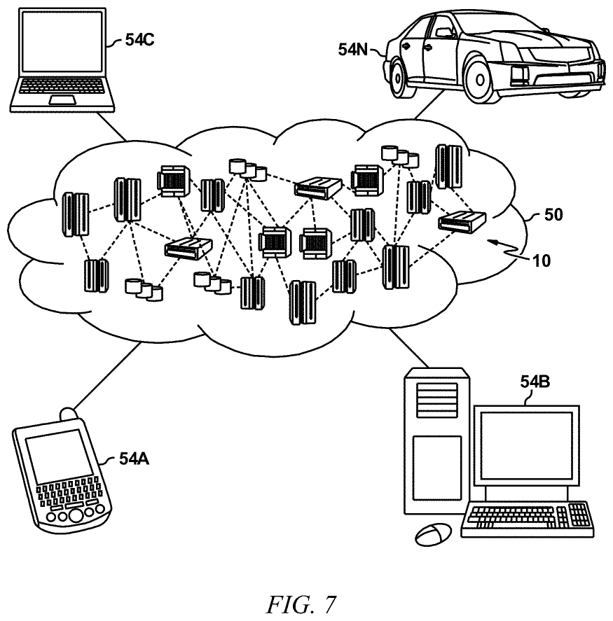

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

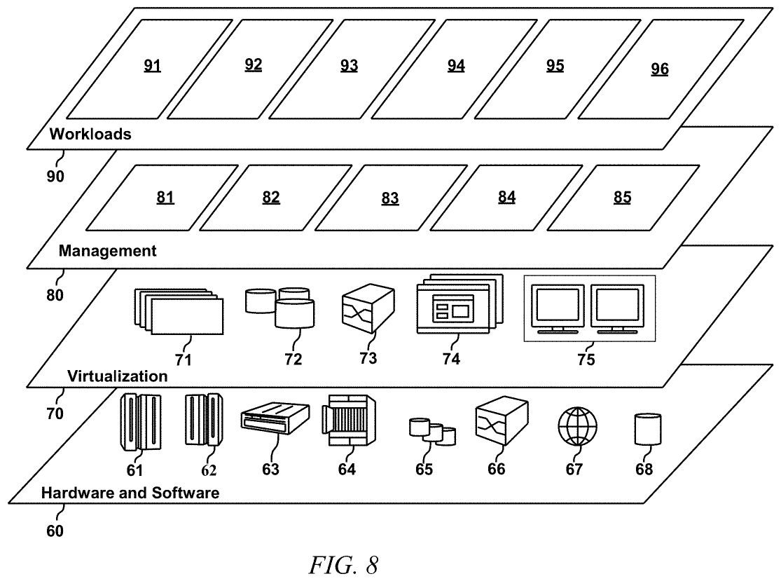

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a feature engineering component 96.

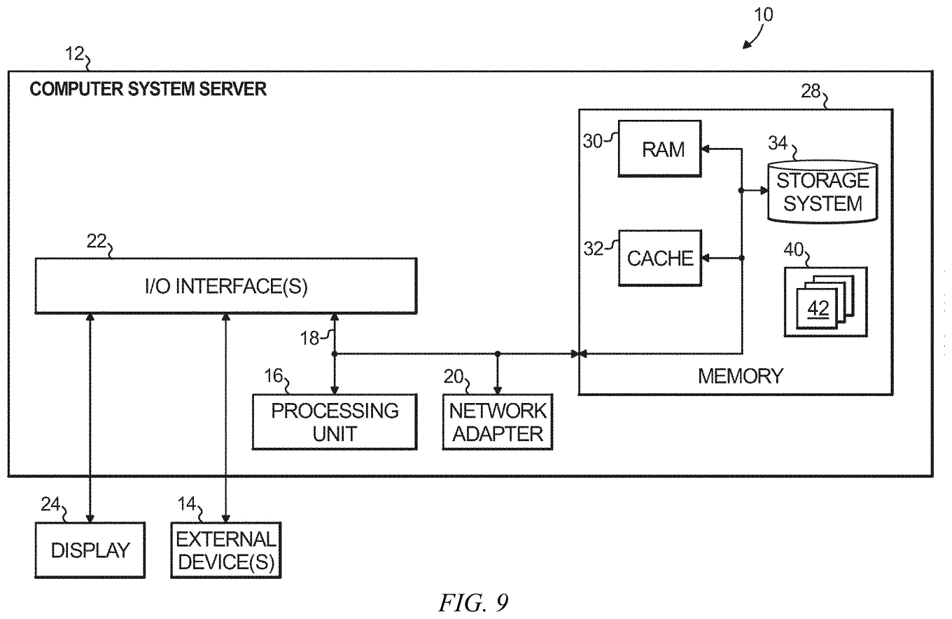

One or more embodiments of the invention, or elements thereof, can be implemented in the form of an apparatus including a memory and at least one processor that is coupled to the memory and operative to perform exemplary method steps. FIG. 9 depicts a computer system that may be useful in implementing one or more aspects and/or elements of the invention, also representative of a cloud computing node according to an embodiment of the present invention. Referring now to FIG. 9, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 9, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 9) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 7-8 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying, using at least one processor, a domain of an input dataset;
identifying, using the at least one processor, one or more archived domain knowledge features corresponding to the identified domain;
inputting, using the at least one processor, one or more user feature definitions for one or more user features defined by a user;
processing, using the at least one processor, the identified archived domain knowledge features and the user features to generate a set of candidate features for presentation to the user;
obtaining, using the at least one processor, a selection of a subset of the candidate features from the user; and
generating, using the at least one processor, one or more predictive models based on the selected features.

2. The method of claim 1, further comprising, using the at least one processor, carrying out inferencing using one or more of the one or more predictive models.

3. The method of claim 2, wherein the processing further comprises providing the candidate features to the user for review and wherein the selection of the subset of the candidate features further comprises one or more modified features generated by the user.

4. The method of claim 2, wherein the user feature definitions are inputted via a user interface (UI).

5. The method of claim 2, wherein the user feature definitions are inputted via a programmatic interface (PI).

6. The method of claim 2, further comprising generating one or more primitive features based on archived formulas, wherein the set of candidate features further comprises the primitive features.

7. The method of claim 6, wherein the processing further comprises checking a validity of one or more of the primitive features, the domain knowledge features, and the user features.

8. The method of claim 6, wherein the processing further comprises providing the primitive features, the archived domain knowledge features, and the user features to a user for review and obtaining a modified set of features from the user.

9. The method of claim 2, wherein the identifying the one or more archived domain knowledge features further comprises generating one or more new domain knowledge features by analyzing metadata for one or more archived datasets obtained from a dataset registry that are similar to the input dataset.

10. The method of claim 2, wherein the processing further comprises reformatting the identified archived domain knowledge features and the user features to comply with a unified format supported by an evaluation module.

11. The method of claim 2, further comprising storing the features, the input dataset, and the identified domain in a feature store and/or a dataset registry.

12. The method of claim 2, wherein carrying out the inferencing using one or more of the one or more predictive models comprises performing natural language processing using one or more of the one or more predictive models.

13. The method of claim 2, further comprising defining, by the user, one or more model generation algorithms for the generation of the predictive models.

14. The method of claim 2, further comprising selecting one or more model generation algorithms for the generation of the predictive models.

15. The method of claim 2, further comprising generating a performance score for each generated predictive model based on one or more benchmark datasets.

16. The method of claim 2, further comprising generating a knowledge graph that relates columns of the input dataset to tags that represent a concept and crafting a derivative feature based on the concept, wherein the set of candidate features further comprises the derivative feature.

17. The method of claim 2, wherein the identifying the domain of the input dataset further comprises comparing the input dataset to datasets in a dataset registry and accessing an identity of a domain corresponding to a similar existing dataset in the dataset registry.

18. The method of claim 2, wherein the inputting of the one or more feature definitions via the user interface (UI) further comprises defining the corresponding user feature in a feature input field and a corresponding textual description in a feature description input field.

19. An apparatus comprising:
a memory; and
at least one processor, coupled to said memory, and operative to perform operations comprising:
identifying a domain of an input dataset;
identifying one or more archived domain knowledge features corresponding to the identified domain;
inputting one or more user feature definitions for one or more user features defined by a user;
processing the identified archived domain knowledge features and the user features to generate a set of candidate features for presentation to the user;
obtaining a selection of a subset of the candidate features from the user; and
generating one or more predictive models based on the selected features.

20. A computer program product for federated learning, the computer program product comprising a computer readable storage medium having program instructions embodied therewith, the program instructions executable by a computer to cause the computer to perform operations comprising:
identifying a domain of an input dataset;
identifying one or more archived domain knowledge features corresponding to the identified domain;
inputting one or more user feature definitions for one or more user features defined by a user;
processing the identified archived domain knowledge features and the user features to generate a set of candidate features for presentation to the user;
obtaining a selection of a subset of the candidate features from the user; and
generating one or more predictive models based on the selected features.
